(19) United States
(12) Patent Application Publication
(10) Pub. No.: US 2006/0092855 A1
(43) Pub. Date: May 4, 2006

(54) Wireless performance optimization based on network topology and peer responsiveness

(76) Inventor: Tom S Chiu, Sunnyvale, CA (US)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/548,992

(22) PCT Filed: Feb. 28, 2004
(86) PCT No.: PCT/IB04/00513

§ 371 Date: Sep. 6, 2005

Related U.S. Application Data
(60) Provisional application No. 60/451,837, filed on Mar. 4, 2003.

(51) Int. Cl. H04J 3/08; H04L 12/28

(52) U.S. Cl. 370/254; 370/315

(57) ABSTRACT

When a node (N) enters a new environment, and periodically thereafter, it initiates a network-learning protocol, wherein the node broadcasts a query at a particular power setting, and receives responses from each of the other nodes (A-F) that received the query. The node then adjusts its power setting, resends the query, and again receives responses to the query. This process is repeated until the node has sent the query throughout a set of power settings. During this process, the node notes which other nodes respond to the query at each power setting the transition point of the power setting at which each node begins to respond defines the electronic-distance, or range, of each node from the querying node. The querying node subsequently uses the range of each node to determine the power setting that it uses to communicate with each node.

This invention relates to the field of communications, and in particular to a system and method for determining the relative location of nodes in a network based on the power levels required to communicate among the nodes.

Communication efficiency can be improved with knowledge of the relative physical location of each node in the network. The power consumed by each node can be reduced by using the minimum power level required to effect each communication. Similarly, the interference among nodes is reduced by reducing the power output of each node whenever feasible.

Networks having a fixed topology are configured for efficient communications by setting the power level at a node for communicating to a particular node based on the known distance between the nodes. Networks with unknown topologies, including ad-hoc networks with dynamic membership and topologies, require a dynamic means for determining the distance between nodes and/or for determining the optimal transmission levels between and among the nodes of the network.

In addition to providing for communication efficiency, knowledge of each node's distance from each other node in a physical environment can facilitate the use of particular location-dependent applications. For example, many home-automation applications and security applications include features or algorithms that are based on the proximity of particular devices, such as the proximity of a user identifier to a particular appliance, a determination of two devices being in the same room, and so on. Similarly, network use and management can be improved by coupling controls and functions based on the proximity of particular devices.

U.S. patent application 2002/0044533A1, published 18 Apr. 2002, presents a direction-based topology control system, wherein messages are relayed as required from node to node from a source node to a destination node, and is incorporated by reference herein. To assure that all nodes are able to reach all other nodes via this relaying/multi-hop technique, each node's transmit power is incrementally increased until its transmission radius includes at least one node within each of a set of transmit-cone angles forming a circle about the node. As taught in this referenced application, if the transmit-cone angles are less than 150 degrees, connectivity among all nodes is assured. Although this arrangement reduces each node's required transmission power, each node must be configured to provide the required relaying function, and each node must include a set of directional receiving antennas.

In “Distributed Power Control in Ad-hoc Wireless Networks”, Proceedings of PIMRC 2001, San Diego, Agarwal et al. teaches a method of determining the required transmission power between nodes wherein the power level used by each node to each other node is determined based on a reported received power level from each of the other nodes. When a source node transmits to a destination node, the destination node acknowledges receipt of the transmission and includes a relative received power level within this acknowledgement. The source node uses this reported received power level to adjust the transmission power for subsequent transmissions to this destination node. Each node maintains a table of reported received power levels and determined transmission power levels for each other node with which it has communicated. The transmission level to each node is initialized at the maximum transmission level, and decremented in response to the reported received power level. In the event of a subsequent lack of acknowledgement to a transmission, the transmit power level to the addressed node is incremented, until an acknowledgement is received, or until the maximum power level is again reached.

In the technique taught by Agarwal et al., each node must be configured to measure and report the received power level, and the communication protocol must include a means of communicating the received power level with the transmission acknowledgements.

It is an object of this invention to provide a performance optimization method and system that does not require substantial modification or enhancement to existing transmission systems. It is a further object of this invention to provide a node optimization process that is applicable to a node, substantially independent of the optimization of other nodes in the network. It is a further object of this invention to optimize the performance of nodes within a network, based on a determination of each nodes location relative to other nodes in the network.

These objects and others are achieved by determining each node's location relative to a given node, based on the transmit power required to reach each of the nodes. When a node enters a new environment, and periodically thereafter, the node initiates a network-learning protocol, wherein the node broadcasts a query at a particular power setting, and receives responses from each of the other nodes that received the query. The node then adjusts its power setting, resends the query, and again receives responses to the query. This process is repeated until the node has sent the query throughout a range of power settings. During this process, the node notes which other nodes respond to the query at each power setting. The transition point of the power setting at which each node begins to respond defines the electronic-distance, or range, of each node from the querying node. The querying node subsequently uses the transition point of each node to determine the power setting that it uses to communicate with each node. Optionally, the querying node also determines the capabilities and functions of each of the other nodes, and uses this information to optimize its performance further by determining alternative routing schemes for communicating with distant nodes that would generally require high power settings. Also optionally, a control node may be configured to collect the range information from a plurality of nodes to determine the two-dimensional physical topology of the nodes in the network.

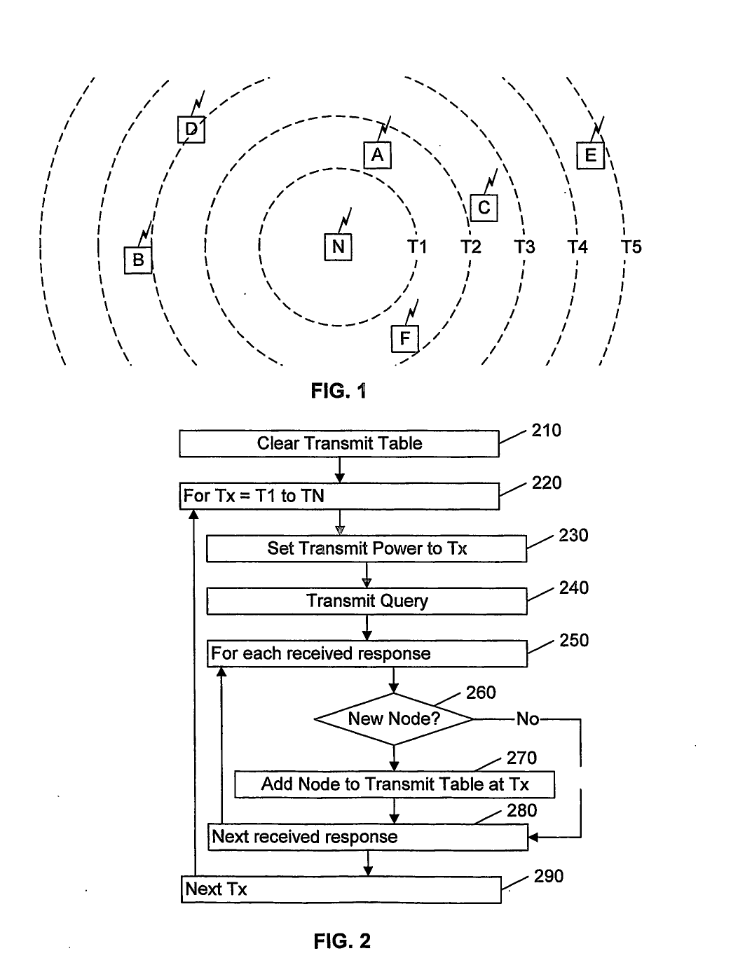

FIG. 1 illustrates an example block diagram of a ranging process in a network of physically distributed nodes in accordance with this invention.

FIG. 2 illustrates an example flow diagram of a ranging process in a network of physically distributed nodes in accordance with this invention.

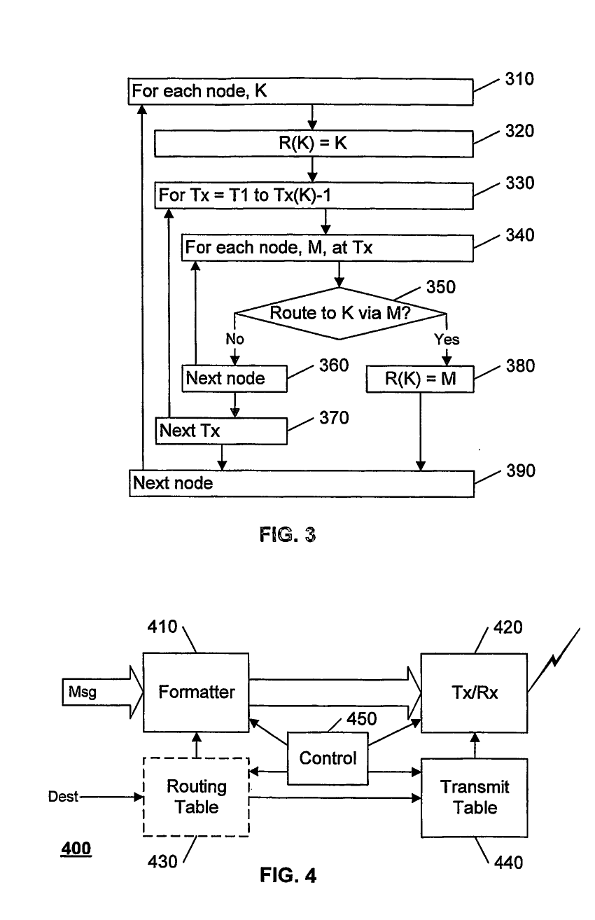

FIG. 3 illustrates an example flow diagram of a routing determination process that facilitates further optimization of node performance in accordance with this invention.

FIG. 4 illustrates an example block diagram of a node in accordance with this invention.

Throughout the drawings, the same reference numeral refers to the same element, or an element that performs substantially the same function.

FIG. 1 illustrates an example block diagram of a ranging process in a network of physically distributed nodes in accordance with this invention. Node N determines the relative electrical-distance, or range, of each other node A-F in the network by transmitting a query at each of a sequence of transmit power levels T1-T5, and noting which of the nodes A-F respond at each power level.

FIG. 2 illustrates an example flow diagram of the ranging process of this invention. A transmit table is maintained at the node N that indicates the minimum power level at which each of the other nodes A-F respond. This table is cleared at 210 in FIG. 2. Within the loop 220-290, the node N sequentially steps through each of a set of power levels T1 to TN. The process of FIG. 2 illustrates an example sequential process from a minimum to maximum power level, although one of ordinary skill in the art will recognize in view of this disclosure that alternative sequences may be used.

At 230, the node N sets its transmit power to the current sequential value Tx, and transmits a query, at 240, at this power level. The query may be any conventional broadcast to which other nodes are expected to reply. The loop 250-280 processes each received response. At 260, the node N determines whether the responding node is newly discovered. Initially, as noted above, the transmit table is cleared, and therefore any responding node is a newly discovered node, and each responding node is entered in the transmit table at the current power level Tx, at 270. Thereafter, at subsequent power levels, the transmit table is checked to determine whether each responding node is already entered in the transmit table. If, at 260, a node is not yet entered in the table, it is entered, at 270; otherwise step 270 is skipped. After stepping through all power levels, all nodes within the range of the node N will be entered in the transmit table. Illustrated below is a sample transmit table corresponding to the network illustrated in FIG. 1.

| | |
|---|---|
| Power | Nodes |

| | | |
|---|---|---|
| T1 | | |
| T2 | A | F |
| T3 | C | |
| T4 | D | B |
| T5 | E | |

Node N subsequently uses this transmit table to determine the preferred power level for communicating with each of the nodes A-F. In a preferred embodiment, the preferred power level is slightly above the power levels used to create the transmit table, to provide a degree of robustness to the communications. Optionally, if the network is dynamic, the node N can be configured to periodically repeat the above node-discovery and locating process to update the transmit table.

As would be evident to one of ordinary skill in the art, the entries in the transmit table can be associated with other characteristics of each node, such as each node's MAC address, IP address, transmit/receive frequency and channel, capabilities, protocols, and so on. In a preferred embodiment, the former locations or ranges of each node is also stored, to facilitate applications that may be dependent upon changes of location, velocity, and so on. Other characteristics of each discovered node may also be determined and associated with each node for subsequent use, such as the power level of the received response to the query from each node. Changes in the power level of received messages from a node, for example, may be indicative of changes in the relative location of the node, and may be used to trigger a repeat of the node-discovery and locating process to update the transmit table.

Note that the above process can be applied to any node that has a controllable output power level, and can be applied regardless of whether any of the other nodes in the network are similarly configured. That is, an embodiment of the process of this invention in a node is compatible with existing conventional network nodes and existing conventional network protocols.

The transmit table above effectively provides a one-dimensional relative location (range) of each node A-F to node N. Optionally, a control node can be configured to receive a normalized version of the transmit table from a plurality of nodes in the network, from which a two-dimensional (range and direction) topology of the network can be determined, using conventional location determination processes. The normalization of the transmit tables effects a mapping of each transmit level T1-T5 of each of the nodes to a common range basis. The two-dimensional topology can subsequently be used to enable particular applications that depend upon the two-dimensional relationship among nodes, such as security systems, home automation systems, and the like.

In accordance with another optional aspect of the invention, the performance of node N is further optimized to use the most power-efficient means to communicate a message to each node. In this embodiment, the node N queries each of the discovered nodes A-F to determine each node's capabilities. As is common in the art, some or all of the nodes A-F may be configured to facilitate the relaying, or routing, of messages to other nodes in the network. If node N can send a message to a distant node via a routing of the message through a closer node, node N can be set to the lower power level of the closer node, and thereby conserve power.

In a preferred embodiment, the preferred routing of messages to each node is determined after discovering the capabilities of each node, and stored in a routing table for subsequent use. FIG. 3 illustrates an example flow diagram of an optional routing determination process that facilitates the further optimization of the node N in accordance with this aspect of the invention. The loop 310-390 determines the optimal scheme for routing a message to each of the nodes in the network. By default, at 320, the route to each node K is via a direct link to node K, wherein when node N has a message to transmit to node K, it uses the above transmit table to determine the appropriate transmit power level for communicating directly to node K, hereinafter referred to as Tx(K).

The loop 330-370 determines whether another node M is available for communicating a message to node K. This loop is configured to check each of the transmit power levels Tx that are below the power level Tx(K) required to communicate directly to node K. As would be evident to one of ordinary skill in the art, it may be determined that a relaying of a message is not efficient if only one or two power levels are saved, compared to a direct communication to node K, and the upper limit of the control loop at 330 can be adjusted accordingly.

Beginning at the lowest power levels, the capabilities of each node M at that power level is check to determine whether the node has the capability of routing a message to node K, at 350. If node M has the capability, the routing for node K, R(K) is adjusted to indicate that messages to node K are routed via node M, at 380, and the search for alternative routings (loop 330-370) to that node is terminated, and the preferred routing for the next node commences, at 390. Thereafter, messages to each of the nodes are routed via the determined preferred routing node for that node, at the preferred routing node's determined power level.

The above routing scheme is based on the one-dimensional (range) topology of a network. As noted above, the range information from a plurality of nodes may be provided to a central-controller to facilitate the two-dimensional topology of a network. Based on this two-dimensional topology, alternative routing paths may be selected to optimize a more global network performance factor, such as the total power expended among all the nodes to communicate a message from node A to node B via each alternative routing path, rather than optimizing the power expended at a particular node. This centralized control may also dynamically alter the preferred routing paths based on possible or actual congestion at an intermediate node, and so on. One of ordinary skill in the art will recognize other optimization possibilities based on one-dimensional and two-dimensional topology determinations.

FIG. 4 illustrates an example block diagram of a node 400 in accordance with this invention. A controller 450 effects the creation of a transmit table 440 via the transmission of a query from a transceiver 420 at each of a series of transmit levels and the detection of responses from other nodes, as detailed above in FIG. 2. Optionally, the controller 450 effects the creation of a routing table 430, as detailed above in FIG. 3.

Formatter 410 formats a subsequent message for transmission to a given destination, optionally using the preferred routing provided in the routing table 430 for the given destination of the message. The formatted message is forwarded to a transceiver 420, and the controller 450 selects the appropriate power level for the transceiver 420 from the transmit table 440, based on either the destination node or the preferred routing node from the optional routing table 430.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

1. A method of facilitating communication among nodes in a network, comprising: sequentially transmitting a query from a Sin the network at each of a plurality of transmit power levels, receiving responses at the first node-N, from one or more other nodes Pin the network at each of the plurality of transmit power levels, and determining a lowest transmit power level of the plurality of transmit power levels Pat which each of the one or more other nodes in the network provided a response, thereby determining a range of each of the one or more other nodes from the first node-N.

2. The method of claim 1, further including adjusting a transmit level at the first node facilitate subsequent communications to a second node of the one or more other nodes, based on the range of the second node from the first node.

3. The method of claim 2, wherein the transmit level is higher than the lowest transmit power level at which the second node provided the response.

4. The method of claim 1, further including determining a routing path from the first node to a second node via a third node whose range from the first node is less than the range of the second node from the first nodes.

5. The method of claim 4, further including adjusting a transmit level at the first node (based on the range of the third node from the first node, to facilitate subsequent communications from the first node to the second node via the routing path.

6. The method of claim 5, wherein the transmit level is higher than the lowest transmit power level at which the third node provided the response.

7. The method of claim 1, further including providing the range of each of the one or more other nodes to a controller to facilitate a further determination of a relative direction of each of the one or more other nodes from the first nodes.

8. The method of claim 1, further including automatically repeating the method to determine changes of the range of each of the one or more other nodes from the first node.

9. A node for communications within a network, comprising: a controllers, a transceiver Shaving a controllable transmit power, and a transmit table that identifies a minimum power setting for communicating with each of one or more other nodes in the network, wherein the controller (facilitates creation of the transmit table by controlling the transmit power of the transceiver to each of a series of transmit power levels transmitting query at each of the series of transmit power levels receiving responses (to the query from the one or more other nodes in the network, and determining the minimum power level required to communicate with each of the one or more other nodes in the network based on the responses.

10. The node of claim 9, wherein the controller is configured to control the transmit power of the transceiver for subsequent communications to a select node of the one or more other nodes in the network based on an entry in the transmit table corresponding to the select node.

11. The node of claim 10, wherein the transmit power is higher than the lowest transmit power level at which the select node provided the response when the transmit table was created.

12. The node of claim 9, further including a routing table, and wherein the controller is further configured to facilitate creation of the routing table by determining a preferred routing path from the node to each of the one or more other nodes in the network, based on the minimum power level required to communicate to a first node on alternative routing paths to each the one or more other nodes.

13. The node of claim 12, wherein the controller is configured to control the transmit power of the transceiver for subsequent communications to a select node the one or more other nodes in the network based on an entry in the transmit table corresponding to an entry in the routing table corresponding to the select node.

14. The node of claim 13, wherein the transmit power is higher than the lowest transmit power level corresponding to the entry in the transmit table when the transmit table was created.

15. The node of claim 9, wherein the controller is further configured to communicate information corresponding to the transmit table to another node in the network to facilitate a determination of a relative range and direction of each of the one or more other nodes from the node.

16. The node of claim 9, wherein the controller is further configured to receive information corresponding to other transmit tables of one or more of the other nodes in the network to facilitate a determination of a relative range and direction of each of the one or more other nodes from the node.
